(19) United States
(12) Patent Application Publication
(10) Pub. No.: US 2020/0311581 A1
(43) Pub. Date: Oct. 1, 2020

(54) HIGH QUALITY PATTERN MINING MODEL AND METHOD BASED ON IMPROVED MULTI-OBJECTIVE EVOLUTIONARY ALGORITHM

(71) Applicant: Jiangnan University, Wuxi (CN)

(72) Inventors: Wei FANG, Wuxi (CN); Qiang ZHANG, Wuxi (CN); Jun SUN, Wuxi (CN); Xiaojun WU, Wuxi (CN)

(21) Appl. No.: 16/885,414

(22) Filed: May 28, 2020

Related U.S. Application Data
(63) Continuation of application No. PCT/CN2019/082839, filed on Apr. 16, 2019.

(51) Int. Cl. G06N 5/04; G06F 16/10; G06N 3/12; G06N 5/00; G06N 20/20; G06F 16/182; G06F 16/11

(52) U.S. Cl. CPC G06N 5/04; G06F 16/10; G06N 3/126; G06F 16/119; G06N 20/20; G06F 16/182; G06N 5/003

(57) ABSTRACT

Disclosed is a high quality pattern mining model and method based on an improved Multi-Objective Evolutionary Algorithm (MOEA), which belongs to the technical field of data mining. By applying a three-objective pattern mining model to item management, and in combination with a comprehensive consideration on support, occupancy, and utility, an itemset easily purchased together by clients and having a high utility value may be mined, which is convenient for a supermarket manager to make a reasonable marketing strategy. Meanwhile, the disclosure constructs an initial population by using a population initialization strategy based on an OR/NOR-tree structure, and in combination with an original database expressed as a bitmap form, and sets a NOR position and an OR position in the OR/NOR-tree structure by using improved crossover and mutation operators, thus solving the problem that in many real-world applications of pattern mining, data is usually large and sparse to lead to the inefficiency of traditional ransom initialization methods and crossover and mutation operators, thereby improving the overall solving efficiency of algorithms.

### TECHNICAL FIELD

The disclosure herein relates to a high quality pattern mining model and method based on an improved Multi-Objective Evolutionary Algorithm (MOEA), and belongs to the technical field of data mining.

### BACKGROUND

Data mining refers to the process of extracting potentially interesting information or patterns from large amounts of data for further use. For example:

Among existing data mining models and methods, Frequent Pattern Mining (FPM) and High Utility Pattern Mining (HUPM) are the fundamental research topics in the field of data mining. The FPM usually uses the support or frequency value to measure the quality of the pattern. However, in practical applications, if only a more frequent pattern is recommended to the user, the pattern is often incomplete. Therefore, based on the support measure, the subsequently improved FPM algorithm proposes an occupancy measure. Although the FPM can explore the frequent occurrences of patterns in transactional databases, it only considers how many transaction items appear in one pattern, and cannot consider the utility (such as profit) of the pattern. However, the utility is important information that cannot be neglected in many practical scenarios. Therefore, the HUPM was proposed that consider the utility measure in the mining model in order to measure the completeness of the pattern in the transactional databases.

Traditional FPM and HUPM algorithms only consider one measure, which either focuses on support or focuses on utility. For example, there're a great variety of items in a supermarket, supermarket manager needs to determine a marketing strategy according to types of the items purchased by clients and profits made from the items. In such a case, if the marketing strategy is determined only according to the frequency that the items are purchased, the profits of the supermarket cannot be maximized. If only the profits are considered, some items that make low profits but are purchased by clients frequently may be excluded, and then the number of clients of the supermarket will be reduced, thereby affecting the operation of the supermarket finally.

According to Pattern Recommendation in Task-oriented Applications: A Multi-Objective Perspective published in 2017, the task-oriented pattern mining problem was transformed into a multi-objective optimization problem; and the MOPM algorithm was proposed to find the patterns that satisfied the conditions. A Multi-objective Evolutionary Approach for Mining Frequent and High Utility Itemsets published in 2018 disclosed an MOEA-FHUI algorithm that considered both the support and the utility to establish a bi-objective optimization problem model for exploring frequent and high-utility patterns.

The above two algorithms focus on frequent and complete patterns only or focus on frequent and high-utility patterns only. However, in real-world applications, users are much more concerned with patterns (i.e., itemset) that not only appear frequently and completely in the datasets, but also make a higher profit. Moreover, with the increasing of the number of target functions, the existing pattern mining algorithms based on evolutionary computation seem to be far from satisfactory. Therefore, it is necessary to establish a novel pattern mining model for the actual diverse requirements of the users, and propose an efficient pattern mining algorithm.

### SUMMARY

In order to solve a problem that current existing data mining models and methods cannot balance support, occupancy, and utility and thus cannot provide complete information for item manager, the disclosure provides a method for mining item information based on a three-objective mining model. The method includes:

establishing a three-objective mining model according to item management information to be obtained, the three-objective mining model being Maximize F(X)={(f₁(X), f₂(X), f₃(X))^{T}}, where the pattern X denotes a combination of distinct items, the relative support f₁(X) of the pattern X is used to measure a frequency that the item included in the pattern X occurs in a transaction dataset D, the occupancy f₂(X) of the pattern X is used to measure the completeness of the pattern X occurring in the transaction dataset D, and the relative utility f₃(X) of the pattern X is used to measure a benefit value of the items included in the pattern X;

solving the established three-objective mining model; and

determining, according to a solution of the three-objective mining model, the item management information to be obtained, wherein

when solving the established three-objective mining model, the following improvements are made to an NSGA-II algorithm:

expressing an original database as a bitmap form, the original database being a transaction record of a shopping place within a certain period of time;

constructing an initial population by using a population initialization strategy based on an OR/NOR-tree structure, and in combination with the original database expressed as the bitmap form;

setting a NOR position and an OR position in the OR/NOR-tree structure by using improved crossover and mutation operators;

adjusting a search direction by using the worst individual search direction adjustment strategy, and based on the OR/NOR-tree structure; and

solving the three-objective mining model by using the improved NSGA-II algorithm.

Optionally, constructing an initial population by using a population initialization strategy based on an OR/NOR-tree structure, and in combination with the original database expressed as the bitmap form includes:

assigning each initial individual a different tree branch, and then distributing the individuals to the following three states:

state 1, initializing one of OR positions corresponding to the individuals as 1 and the other positions as 0;

state 2, initializing all OR positions corresponding to the individuals as 1, and all NOR positions as 0; and

state 3: randomly initializing the corresponding OR positions of the individuals as 0 or 1, and initializing all NOR positions as 0.

Optionally, the setting a NOR position and an OR position by using improved crossover and mutation operators includes:

generating a new individual by using a uniform crossover operator, and setting a NOR position corresponding to the new individual as 0; and

using a bitwise mutation operation for a mutation operator, and only performing a mutation operation on an OR position corresponding to the individual.

Optionally, adjusting a search direction by using the worst individual search direction adjustment strategy, and based on the OR/NOR-tree structure includes:

in case of the total number of OR/NOR-tree branches is greater than the population size, replacing the search direction of the worst individual in the current population during iteration each time.

Optionally, the replacing the search direction of the worst individual in the population includes: selecting the worst individual in a present generation according to a non-dominated sorting and crowding distance, and re-assigning an OR/NOR-tree branch to the individual.

Optionally, the improved NSGA-II algorithm uses a binary encoding mechanism, and the selection operation uses a binary tournament selection method.

Optionally, supposing that an itemset included in the transaction dataset D is M={item₁, item₂, . . . , item ⱼ, . . . , itemₘ}, there are m types of items in total, the pattern X denotes a combination of distinct items, D={T₁, T₂ . . . Tᵢ, . . . Tₙ } is a transaction dataset, the Tᵢ is a single piece of transaction data in the transaction dataset D, the |D| is the number of transaction data in the D, and |D|=n,

$${f}_{1} ( X ) = sup ( X ) = \frac{\vert \{ {T}_{i} \vert X ⊆ {T}_{i} , {T}_{i} ∈ D \} \vert}{\vert D \vert} .$$

Optionally,

$${f}_{2} ( X ) = o c c u ( X ) = \frac{{\sum }_{T ∈ {T}_{x}} \frac{\vert X \vert}{\vert {T}_{i} \vert}}{\vert {T}_{x} \vert} ,$$

where the Tₓ denotes transaction data of an item included in the pattern X in the transactional dataset D, and the |Tₓ| denotes the number of transaction data pieces of the item included in the pattern X.

Optionally,

$${f}_{3} ( X ) = u t i ( X ) = \frac{{\sum }_{{T}_{q} ∈ {T}_{X}} {\sum }_{{i}_{j} ∈ X , X ⊆ {T}_{q}} q ( {i}_{j} , {T}_{q} ) \times p ( {i}_{j} )}{{\sum }_{{T}_{q} ∈ D} TU ( {T}_{q} )} ,$$

where the Tq ∈ D is a q-th piece of transaction data, the iⱼ is an abbreviation of itemⱼ and denotes a j-th type of items in the m types of items, the q (iⱼ, T_{q}) denotes the number of the items of the j-th type included in the q-th piece of transaction data, the p(iⱼ) denotes a weight for the j-th type of items, the TU(T_{q}) denotes utility generated by the q-th piece of transaction data, 1≤j≤m, and 1≤q≤n.

The disclosure has the following beneficial effects:

By applying a three-objective pattern mining model to item management such as supermarket item management, and in combination with a comprehensive consideration of support, occupancy, and utility, an itemset easily purchased together by clients and having a high utility can be discovered, which is convenient for supermarket manager to make a reasonable marketing strategy. Meanwhile, most traditional pattern mining methods need to set prior parameters, so it is a difficult problem for users without any experience to set an appropriate parameter threshold. The disclosure constructs an initial population by using a population initialization strategy based on an OR/NOR-tree structure, and in combination with an original database expressed as a bitmap form, and sets a NOR position and an OR position in the OR/NOR-tree structure by using improved crossover and mutation operators, thus solving a problem that in many practical applications of pattern mining, data is usually large and sparse to lead to inefficiency of traditional ransom initialization methods and crossover and mutation operators, and improving the overall solving efficiency of algorithms; and in addition, the disclosure further adjusts the search direction by using the worst individual search direction adjustment strategy to improve optimization processes and optimization results, thus achieving purposes of improving the convergence speed and guaranteeing the quality of final solutions.

### BRIEF DESCRIPTION OF FIGURES

In order to more clearly illustrate the technical solutions of embodiments of the disclosure, the drawings which are required to be used in the description of the embodiments will be briefly described below. It is obvious that the drawings described below are only some embodiments of the disclosure. It will be apparent to one of ordinary skill in the art that other drawings may be obtained based on the accompanying drawings without inventive effort.

FIG. 1 is a diagram of an example OR/NOR-tree structure.

FIG. 2 is a diagram of improved crossover and mutation operators.

FIGS. 3A-3D is a schematic diagram for obtaining a final non-dominant solution set by using an MOEA-PM algorithm on four datasets.

FIG. 4 is a schematic diagram of a Pareto optimal solution of different algorithms on Accident_10%.

FIG. 5 is a schematic diagram of a Pareto optimal solution of different algorithms on Chess.

FIG. 6 is a schematic diagram of a Pareto optimal solution of different algorithms on Connect_50%.

FIG. 7 is a schematic diagram of a Pareto optimal solution of different algorithms on Mushroom.

FIGS. 8A-8D is a schematic diagram showing a change of an HV of different algorithms at different numbers of evaluations on four datasets.

FIGS. 9A-9D is a schematic diagram showing a change of a COV of different algorithms at different numbers of evaluations on four datasets.

### DETAILED DESCRIPTION

To make the purpose, technical solutions, and advantages of the disclosure clearer, embodiments of the disclosure will be described below in detail with reference to the drawings.

### Embodiment 1

This embodiment provides a method for mining item information based on a three-objective mining model, applied to item management of a shopping place, including the following steps:

Establishing a three-objective mining model according to item management information to be obtained, the three-objective mining model being Maximize F(X)={(f₁(X), f₂(X), f₃(X))^{T}}, where the pattern X denotes a combination of distinct items, the relative support f₁(X) of the pattern X is used to measure a frequency that the item included in the pattern X occurs in a transaction dataset D, the occupancy f₂(X) of the pattern X is used to measure the completeness of the pattern X occurring in the transaction dataset D, and the relative utility f₃(X) of the pattern X is used to measure a benefit value of the item included in the pattern X.

Solving the established three-objective mining model.

Determining, according to a solution of the three-objective mining model, the item management information to be obtained.

Solving the established three-objective mining model by using an improved NSGA-II algorithm:

Specifically, supposing that an itemset included in the transaction dataset D is M={item₁, item₂, . . . , itemⱼ, . . . , itemₘ}, there are m types of items in total, the pattern X denotes a combination of distinct items, D={T₁, T₂. . . Tᵢ, . . . Tₙ} is a transaction dataset, the Tᵢ is a single piece of transaction data in the transaction dataset D, the |D| is the number of transaction data in the D, and |D|=n,

$${f}_{1} ( X ) = sup ( X ) = \frac{\vert \{ {T}_{i} \vert X ⊆ {T}_{i} , {T}_{i} ∈ D \} \vert}{\vert D \vert} . \\ {f}_{2} ( X ) = occu ( X ) = \frac{{\sum }_{T ∈ {T}_{x}} \frac{\vert X \vert}{\vert {T}_{i} \vert}}{\vert {T}_{x} \vert} ,$$

where the Tₓ denotes transaction data of an item included in the pattern X in the transaction dataset D, and the |Tₓ| denotes the number of transaction data pieces of the item included in the pattern X.

$${f}_{3} ( X ) = u t i ( X ) = \frac{{\sum }_{{T}_{q} ∈ {T}_{X}} {\sum }_{{i}_{j} ∈ X , X ⊆ {T}_{q}} q ( {i}_{j} {T}_{q} ) \times p ( {i}_{j} )}{{\sum }_{{T}_{q} ∈ D} TU ( {T}_{q} )} ,$$

where the Tq ∈ D is a q-th piece of transaction data, the iⱼ is an abbreviation of itemⱼ and denotes a j-th type of items in the m types of items, the q(iⱼ,T_{q}) denotes the number of the items of the j-th type included in the q-th piece of transaction data, the p(iⱼ)denotes a weight for the j-th type of items, the TU(T_{q}) denotes utility generated by the q-th piece of transaction data, 1≤j≤m, and 1≤q≤n.

As shown in Table I below, it is assumed that Table I is a shopping list of a supermarket within a period of time, i.e., an original dataset D, the shopping list includes 10 transaction records Tᵢ in total, and each transaction record includes a plurality of items and corresponding purchase quantities.

TABLE I
Example database

| | Transaction (item, | Transaction utility |
|---|---|---|
| T_{ID} | quantity) | (TU) |
| T₁ | {b:3, c:1,f:4} | 37 |
| T₂ | {c:2, d:3, g:1} | 31 |
| T₃ | {a:5, e:3} | 27 |
| T₄ | {a:4, c:5, e:2, f:2, g:1} | 58 |
| T₅ | {a:5, b:9} | 24 |
| T₆ | {b:15,f:3} | 39 |
| T₇ | {b:2, c:5} | 12 |
| T₈ | {a:3, b:5, c:4} | 22 |
| T₉ | {e:3,f:2} | 28 |
| T₁₀ | {a:5, b:6, c:1, f:2} | 39 |

TABLE II
Profit table

| Item | a | b | c | d | e | f | g |
|---|---|---|---|---|---|---|---|
| Profit | 3 | 1 | 2 | 5 | 4 | 8 | 12 |

As can be seen from Table I, the original transactional dataset D has shown in Table I has an itemset M={a, b, c, d, e, f, g}, and there're m=7 items in total. Table II shows the corresponding profit value of each item. The pattern X refers to a combination of distinct items, for example, the pattern {a, f, g} represents a combined pattern of item a, item f, and item g.

Referring to Table I and Table II, the |D| is a total transaction quantity in D. In the transactional dataset shown in Table I, |D|=10. In the transactional dataset D, each piece of transaction data Tq ∈ D (1≤q≤n)(n=10) is composed of a plurality of items.

Each item in the transaction data T_{q} has a purchase quantity (internal utility), which is denoted as q(iⱼ,T_{q})(1≤j≤m, 1≤q≤n). In the itemset M={item₁, item₂, . . . , itemⱼ, . . . , itemₘ} each item has an external utility p(iⱼ), indicating the profit of the item.

An itemset (or pattern) X={i₁, i₂, . . . , iₖ}(1≤k≤m) is a non-empty subset of an itemset M.

Tₓ denotes a transaction that contains all the items in the itemset X. In the dataset, if one itemset has support sup(X) of not less than minimum support (minSup), the itemset is called as a frequent itemset, which is also referred to as a frequent pattern. If one itemset has occupancy occu(X) of not less than a minimum occupancy threshold (minSup), the itemset is called as a dominant itemset, which is also referred to as a dominant pattern. Similarly, if one itemset has the utility of not less than a minimum utility threshold (minUti) set by a user, the itemset is a high-utility itemset, which is also referred to as a high-utility pattern.

For example, the transaction record T₁ includes three types of items, item b, item c, and item f. In this transaction record, the purchased quantities of the items are 3, 1, and 4. The TU denotes a total profit corresponding to each transaction record. In the transaction record T₁, a profit value brought to a shopping mall is 37 in total; and by summating the TU, a total profit brought by the shopping list to the supermarket is obtained.

The (relative) support of the pattern X is defined as follows:

$$sup ( X ) = \frac{\vert \{ {T}_{i} \vert X ⊆ {T}_{i ′} {T}_{i} ∈ D \} \vert}{\vert D \vert}$$

For example, in Table I, the support of the pattern {b, c} is sup({b, c})= 3/10, since the {b, c} appears in T₁, T₇ and T₁₀ in the example database. Similarly, sup({c, g})= 2/10, since the pattern {c, g} appears in T₂ and T₄.

Supposing that the minimum support threshold minSup=0.25, since sup({b, c})≥minSup, the itemset {b, c} is the frequent pattern. As sup({c, g})<minSup, the itemset {c, g} is not the frequent pattern.

For any two patterns X and Y, if no itemset allows X⊆Y, the X may be viewed as a maximal pattern. In Table I, it is obvious that the itemset {b, c, f} is not the maximal pattern since {b, c, f}⊆T₁₀. The itemset {a, b} is also not the maximal pattern as {a, b}⊆T₈. The itemset {c, d, g} is the maximal pattern since there is no itemset in the transaction dataset shown in Table I that can contain {c, d, g}.

The occupancy is used to measure the completeness of the pattern, and is defined as follows:

$$occu ( X ) = \frac{{\sum }_{T ∈ {T}_{x}} \frac{\vert X \vert}{\vert {T}_{i} \vert}}{\vert {T}_{x} \vert}$$

For example, for the pattern {b, c} in Table I, it is in the transactions T₁, T₇, and T₁₀. Then, the occupancy of the pattern is occu({b, c})=(2/3+2/2+2/4)/3≈0.72. If the minimum occupancy threshold minOccu=0.6, this pattern is called as the dominant pattern as occu({b, c})>minOccu.

The (relative) utility of the itemset X is defined as:

$$u t i ( X ) = \frac{{\sum }_{{T}_{q} ∈ {T}_{X}} {\sum }_{{i}_{j} ∈ X , X ⊆ {T}_{q}} q ( {i}_{j} , {T}_{q} ) \times p ( {i}_{j} )}{{\sum }_{{T}_{q} ∈ D} TU ( {T}_{q} )}$$

For example, the utility of the pattern {c, f} is:

uti({c, f})=((1×2+4×8)+(5×2+2×8)+(1×2+2×8))/(37+31+27+58+24+39+12+22+28+39)≈0.25. If the minimum utility threshold minUti is less than this value, the itemset {c, f} is the high-utility itemset, which is also known as the high-utility pattern.

When solving the three-objective model, the following improvements are made based on the NSGA-II algorithm:

Expressing an original database as a bitmap form.

Scanning the original database to find all maximal patterns and all distinct items, and constructing an OR/NOR-tree structure according to the maximal pattern.

Constructing an initial population according to the constructed OR/NOR-tree structure.

Generate a new individual by using a uniform crossover operator, and then set a NOR position corresponding to the individual as 0 according to an OR/NOR-tree branch corresponding to the individual.

Using a bitwise mutation operation for the mutation operator, and only perform a mutation operation on an OR position corresponding to the individual.

In case the total number of OR/NOR-tree branches is greater than an item size, replacing a search direction of the worst individual in a current population during iteration each time.

Solving the model by using the improved NSGA-II algorithm.

The above MOEA-PM algorithm for solving the three-objective pattern mining model provided by the disclosure is as follows:

Algorithm 1: MOEA-PM

```
Input:
  D: the transaction dataset;
  a stopping criterion;
  n: the number of the populations;
Output: Non-dominated solutions, i.e., a set of
non-dominated patterns
Step 1) Initialization:
Step 1.1) (MP, items) ← MaximalPattern(D); // Scan the dataset
to find all the maximal patterns and all the distinct items.
Step 1.2) tree ← OrNorTree(MP, items); // Construct the
OR/NOR-tree according to the maximal patterns.
Step 1.3) P₀ ← Initialization(D, n, tree); // Initialize the
population based on the OR/NOR-tree results.
Step 1.4) P₀ ← Evaluate(P₀); //Evaluate an objective
function value of the initialized population.
Step 1.5) P₀ ← Sorting(P₀); // Calculate a non-dominated
sorting and crowding distance
Step 1.6) k ← 0; // Initialize an iteration counter.
Step 2) Evolving populations based on NSGA-II:
Step 2.1) while the stopping criterion is unsatisfied, do
Step 2.2) MPₖ ← TournamentSelection(Pₖ); // Generate a mating
pool based on the binary tournament selection method.
Step 2.3) Qₖ ← GeneticOperators(MPₖ); // Generate a new
population by using an improved genetic operator.
Step 2.4) Qₖ ← Evaluate(Qₖ); // Evaluate an objective
function value of the new population.
Step 2.5) Pₖ₊₁ ← Elitist(Pk ∪ Qk); // Elitist strategy.
Step 2.6) Pₖ₊₁ ← ChangeDirection(Pₖ₊₁); //adjust a search
direction of the worst individual.
Step 3) Stopping criterion: If stopping criterion is satisfied, then
stop and go to Step 4, otherwise k ← k+1, go to Step 2.
Step 4) Get a final solution
Step 4.1) Patterns ← FinalSolution(P_{end}); // Select a better
pattern from the final population as the final solution
```

Most traditional pattern mining methods need to set prior parameters, so it is a difficult problem for users without any experience to set an appropriate parameter threshold. The disclosure uses a multi-objective evolutionary algorithm to optimize the above problem model and can explore a pattern to meet a specified condition without setting a threshold. In addition, for the problem that in many practical applications of pattern mining, data is usually large and sparse to lead to inefficiency of traditional random initialization methods and crossover and mutation operators, the disclosure proposes a novel population initialization method, which ensures the effectiveness and diversity of individuals in the initial population while ensuring that the initial population has a high evolutionary starting point. Furthermore, the disclosure further develops improved crossover and mutation operators for this problem, as well as a search direction replacement strategy for poor individuals in the population to improve optimization processes and optimization results. The disclosure uses a binary encoding approach, in which “1” indicates the presence of an item, and “0” indicates absence of a corresponding item.

Specifically, the disclosure uses a novel population initialization method based on an NSGA-II algorithm. In the research process of traditional multi-objective optimization theories, a random population initialization method is often used. When the random population initialization method initializes data that is distributed sparsely, there is a pattern that most of the initial individuals are distributed out of the solution space, and the population has many infeasible solutions before being evolved, which greatly reduces a computational efficiency of the algorithm. Therefore, the disclosure uses a novel population initialization strategy based on an OR/NOR-tree structure to initialize the data, to ensure that the initial population is effectively distributed in the solution space.

The above Table I provides an original dataset. The original dataset is expressed as a bitmap form, and the original database is a transaction record of a shopping place within a certain period of time.

Suppose D={T₁, T₂, . . . T_{q} . . . , Tₙ} is a quantitative database, and I={i₁, i₂, . . . , iᵥ} is a collection of all the distinct items in the database. The bitmap of D is an n×v Boolean matrix, denoted as B(D).

The value of the j-th row (1≤j≤n) and the k-th column (1≤k≤v) of B(D), i.e. B_{j,k} is calculated as follows:

$${B}_{j , k} = \{ \begin{matrix}1 , & if {i}_{k} ∈ {T}_{j} \\ 0 , & otherwise\end{matrix}$$

The bitmap representation of the example database in Table I is given in Table III.

TABLE III
Bitmap representation of example database

| T_{ID} | a | b | c | d | e | f | g |
|---|---|---|---|---|---|---|---|
| T₁ | 0 | 1 | 1 | 0 | 0 | 1 | 0 |
| T₂ | 0 | 0 | 1 | 1 | 0 | 0 | 1 |
| T₃ | 1 | 0 | 0 | 0 | 1 | 0 | 0 |
| T₄ | 1 | 0 | 1 | 0 | 1 | 1 | 1 |
| T₅ | 1 | 1 | 0 | 0 | 0 | 0 | 0 |
| T₆ | 0 | 1 | 0 | 0 | 0 | 1 | 0 |
| T₇ | 0 | 1 | 1 | 0 | 0 | 0 | 0 |
| T₈ | 1 | 1 | 1 | 0 | 0 | 0 | 0 |
| T₉ | 0 | 0 | 0 | 0 | 1 | 1 | 0 |
| T₁₀ | 1 | 1 | 1 | 0 | 0 | 1 | 0 |

Before initialization, firstly, scan the database to find all maximal patterns and all distinct items, and then construct an OR/NOR-tree structure according to the maximal patterns.

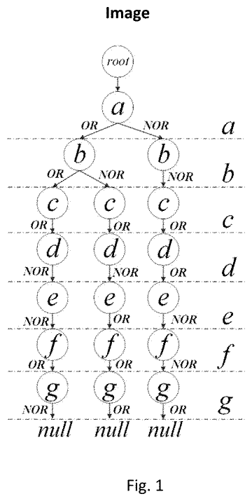

For example, all the maximal patterns of the database in Table I are {a, b, c, f}, {a, c, e, f, g} and {c, d, g}. The corresponding OR/NOR-tree structure is shown in FIG. 1. The OR indicates that a corresponding item may be present in a chromosome, and may also be absent (that is, the value of the corresponding position is 0 or 1); and the NOR indicates that the corresponding item does not exist in the chromosome (i.e., the value of the corresponding position is 0).

For example, an itemset {a, b, c, d} cannot be generated because the combination does not match any branch in the OR/NOR-tree, i.e., nobody purchases items a, b, c, and d at the same time. The itemset {c, e, f} can be generated because the combination satisfies the middle branch.

For the purpose of reflecting the distribution of the solution to a greater extent with the limited number of individuals, a different tree branch is assigned to each initial individual first, and then the individuals are distributed to the following three states:

State 1, initialize one of OR positions corresponding to the individuals as 1 and the other positions as 0.

State 2, initialize all OR positions corresponding to the individuals as 1, and all NOR positions as 0.

State 3: randomly initialize corresponding OR positions of the individuals as 0 or 1, and initialize all NOR positions as 0.

The above state 1 and state 2 can ensure the coverage of the initial population to the boundary region in the solution space, and the state 3 can ensure the uniform coverage to the non-boundary region of the solution space.

The initialization strategy improves the convergence speed and searches efficiency of the algorithm to some extent. The effectiveness of the strategy will be studied in the experimental section.

After the data is initialized,

Set a NOR position and an OR position in the OR/NOR-tree structure by using improved crossover and mutation operators.

First, generate a new individual by using a uniform crossover operator, and then set a NOR position corresponding to the individual as 0 according to an OR/NOR-tree branch corresponding to the individual.

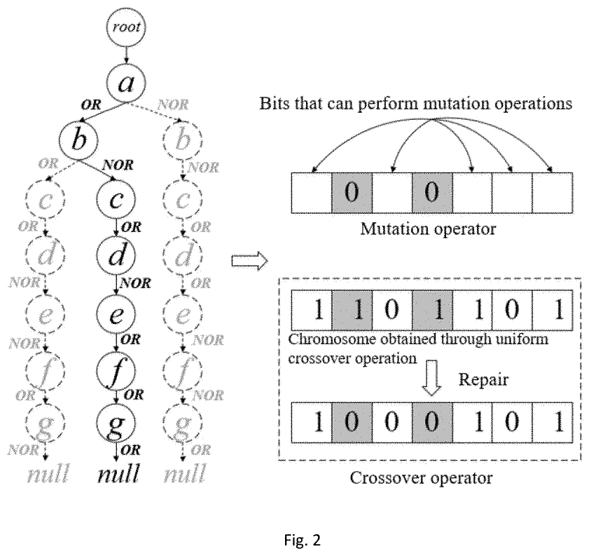

As shown in FIG. 2, it is assumed that one of the new chromosomes obtained by the uniform crossover operation of chromosome A and chromosome B is A′=(1101101), and assumed that the tree branch corresponding to the chromosome A is the middle of the left OR/NOR-tree in the above figure, and then a NOR position in the corresponding tree branch of the chromosome is set to 0, and finally A′=(1000101).

Similarly, for the mutation operator, use the bitwise mutation operation to perform the mutation operation on the corresponding OR position on each chromosome.

For example, (1101100) is not possible for a chromosome assigned to the intermediate branch since the second and fourth positions of the code must be 0. And (1010101) may be generated because it satisfies the requirement that the second and fourth positions are 0.

Through the above operations, while ensuring that the child individuals fully inherit advantages of the parent individuals, it is also ensured that the itemset represented by the new individual is a combination of valid items in the dataset. Thereby, the generation of meaningless itemset combination is avoided, the ability of the algorithm to explore an effective solution space is improved, and the convergence speed of the algorithm is accelerated.

After the crossover and mutation operators are improved, adjust a search direction of the OR/NOR-tree structure by using the worst individual search direction adjustment strategy.

In case the total number of OR/NOR-tree branches is greater than the population size, replace the search direction of the worst individual in the current population during iteration each time, to ensure the effective search for the solution space domain, that's because, in this case, only using the foregoing improvement method may not expand the search space to the region where a global optimal solution is located, which results in that it is very difficult to get the global optimal solution. Therefore, on the basis of the above content, the worst individual search direction adjustment strategy is proposed. The specific process can be summarized as follows:

For individuals who will enter the next generation in the evolution of the population, select the worst individual in this generation based on the non-dominated sorting and crowding distance, and reassign the OR/NOR-tree branches to the individuals. It is equivalent to modifying the search direction of the worst individuals. This strategy may improve the global search ability of the algorithm to the solution space to some extent.

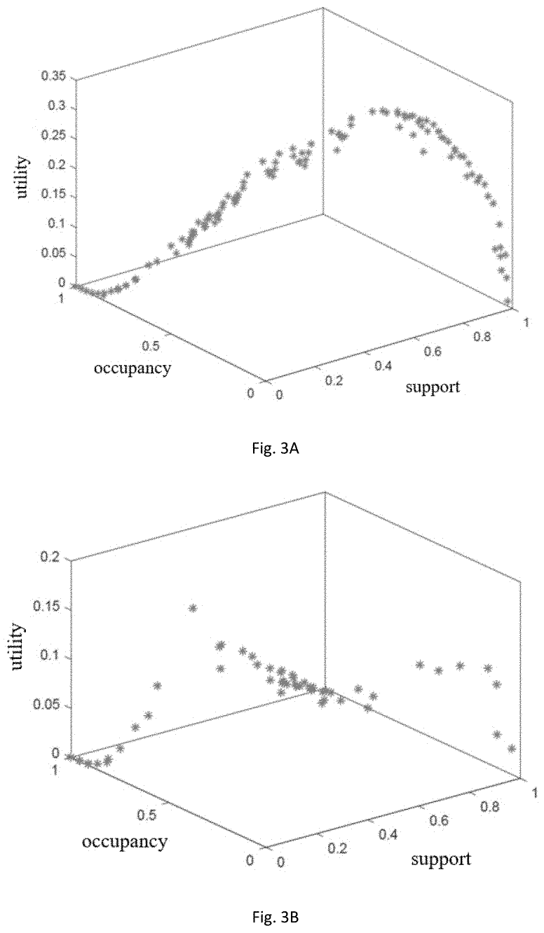

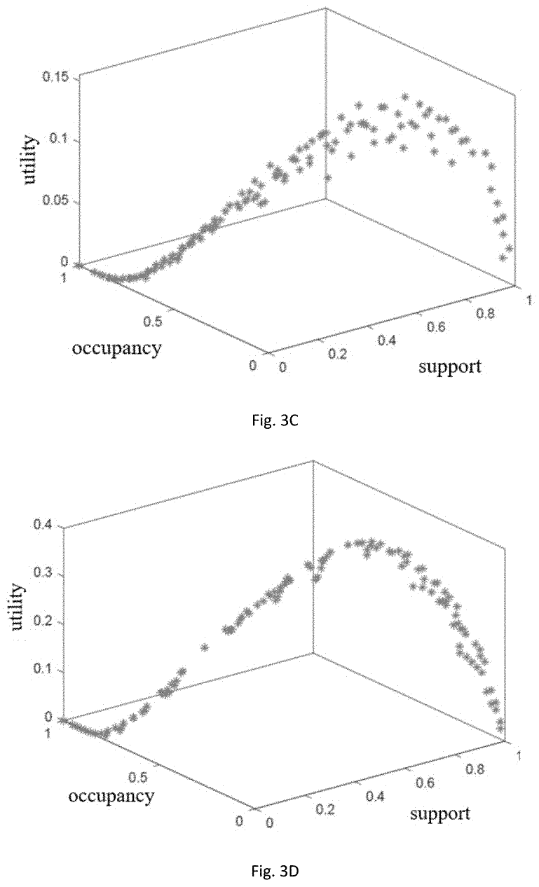

In the process of solving the three-objective pattern mining model proposed by the disclosure by using the above algorithms, a desktop computer of 64-bit Windows 10 with an Intel Core i3-4170 3.70 GHz CPU and 8 G RAM is used. The algorithms were implemented in Matlab. Four disclosed real-world datasets, which are Chess, Mushroom, Accident, and Connect, are used to evaluate the performance. All the datasets can be downloaded from the SPMF data mining library since some datasets are quite large. In order to explain the problem more simply, only the previous 10% of Accident and previous 50% of Connect are adopted. Table IV describes the relevant parameters of the datasets; Table V describes the parameters and characteristics of the above four real-world datasets in detail. FIGS. 3A-3D is a schematic diagram for obtaining a final non-dominant solution set by using the MOEA-PM algorithm on four datasets. FIG. 3A is corresponding to the chess dataset. FIG. 3B is corresponding to the mushroom dataset. FIG. 3C is corresponding to the accident_10% dataset. FIG. 3A is corresponding to the connect_50% dataset.

TABLE IV
Parameters of used datasets

| | |
|---|---|
| #Transactions | Total number of |
| | transactions |
| #Items | Number of distinct |
| | items |
| AvgLen | Average length of |
| | transactions |
| MaxLen | Maximal length of |
| | transactions |

TABLE V
Characteristics of used datasets

| Dataset | #Transactions | #Items | AvgLen | MaxLen |
|---|---|---|---|---|
| Chess | 3196 | 76 | 37 | 37 |
| Mushroom | 8124 | 120 | 23 | 23 |
| Accident_10% | 34018 | 469 | 34 | 46 |
| Connect_50% | 33779 | 129 | 43 | 43 |

The performance of the proposed MOEA-PM is also compared with several state-of-the-art algorithms and their variants.

1) MOEA-PM-: in order to illustrate the effectiveness of the proposed improved genetic operators, we compared it with a variant of the MOEA-PM algorithm, MOEA-PM-in which: only population initialization strategy in the MOEA-PM algorithm is included, and the improved genetic operator is replaced with a genetic operator.

2) MOPM: two kinds of patterns are defined in the MOPM algorithm, namely a transaction-pattern and meta-pattern to generate the initial population. The transaction-patterns usually have high occupancy but small support values, and the meta-patterns usually have high support but small occupancy values. Therefore, more diverse solutions can be obtained by using this algorithm for pattern mining.

3) MOEA-FHUI(NSGA-II): the MOEA-PM algorithm is also compared with the latest MOEA-FHUI algorithm in terms of the effectiveness and the mining efficiency. This algorithm uses meta-itemset and transaction-itemset to initialize the population. Different from the MOPM algorithm, it randomly initializes the population according to the support value of the meta-itemset and the utility value of the transaction-itemset as the selected probability. To ensure fairness, all algorithms are based on the NSGA-II algorithm. Therefore, MOEA-FHUI is termed as MOEAFHUI (NSGA-II).

4) MOEA-PM (Random):in order to illustrate the effectiveness of the population initialization strategy proposed in MOEA-PM, a variant of the MOEA-PM algorithm is taken for comparison, which is called as MOEA-PM(Random). MOEA-PM(Random) adopts a random population initialization strategy, and the other components are the same as MOEA-PM.

5) MOEA-PM(Meta.) and MOEA-PM(Tran.): the MOEA-PM (Meta.) and MOEAPM (Tran.) are two variants of the MOEA-PM algorithm, and are used in the next comparison experiment to illustrate the effectiveness of the proposed population initialization strategy. In MOEA-PM (Meta.), the initial population is composed of randomly meta-patterns. In MOEA-PM (Tran.), the initial population is composed of transaction-patterns. Similarly, the other components are the same as MOEA-PM.

It should be noted that in order to ensure fairness of comparison, all the above algorithms adopt the binary encoding mechanism and the selection operation adopts the binary tournament selection method. In addition to MOEA-PM and its variants, other algorithms use uniform crossover operators and bitwise mutation operators. For the mutation operator, the probability of mutation is Pₘ=1/|I| supposing that the total number of distinct items in the dataset is I.

To evaluate the quality of the final pattern mined by the MOEA-PM algorithm, Hypervolume (HV) and Coverage (COV) are adopted as the performance metrics.

Hypervolume (HV) is one of the evaluation indicators in the EMO field. This indicator can comprehensively reflect the convergence and diversity of solution sets to some extent, with a calculation formula as follows:

HV=λ(Uᵢ₌₁^{|A|}volᵢ)

Where, the λ is a Lebesgue measure, the A represents a set of non-dominant solutions, and the volᵢ represents the HV which is measured by the reference point and the non-dominated individual pᵢ. The larger the HV value, the better the performance of solution sets obtained by the algorithm.

Coverage (COV) is a commonly used evaluation indicator in the recommendation system. It refers to the proportion of items recommended by the algorithm to the total set of items, with the following calculation formula:

$$C O V = \frac{{N}_{d}}{N}$$

Where the N_{d} indicates the number of distinct items in the recommendation lists and the N is the number of all items. If the coverage value of the obtained solution set of the algorithm is relatively low, it means that a solution range obtained by this algorithm is limited, which will reduce the user's satisfaction, since a low coverage value means that the user can select fewer items. Similar to the HV indicator, the larger the value of the COV indicator, the better the to-be-recommended pattern obtained by the algorithm.

For all the algorithms, by setting the population size as 100 and the number of evaluations as 5000, the quality of a non-dominant solution set obtained by each algorithm with a less number of fitness evaluations is observed.

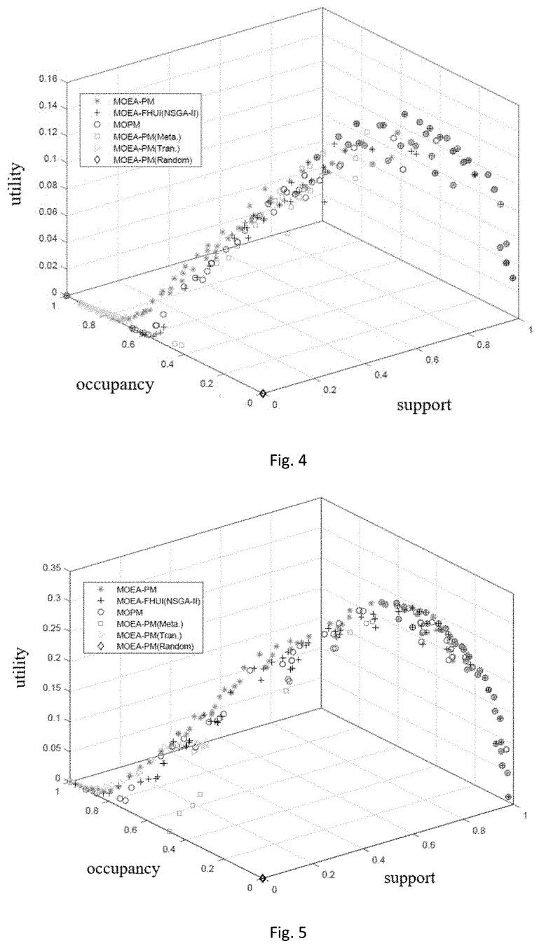

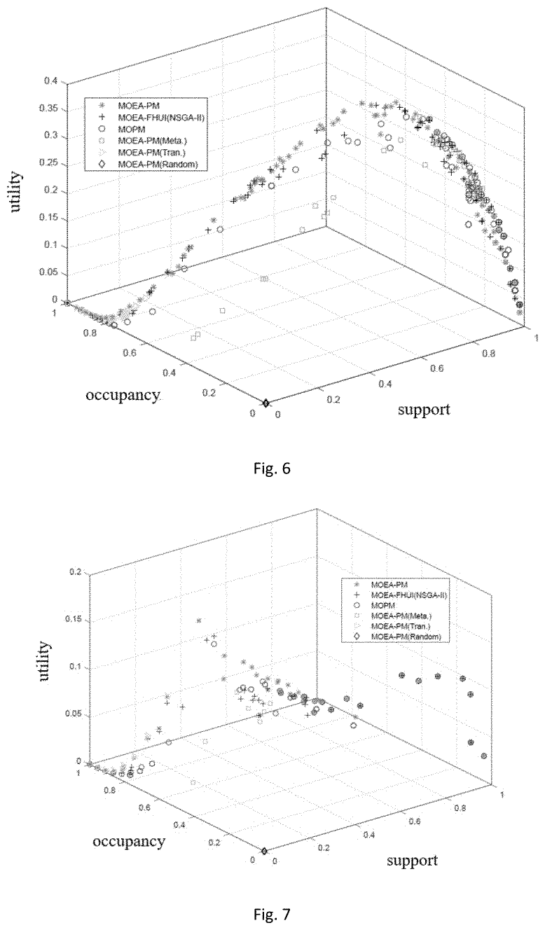

The Pareto optimal solution set obtained by each algorithm on the four real-world datasets are shown in FIG. 4 to FIG. 7.

As can be seen from FIGS. 4 to FIG. 7, in the four real-world datasets, regardless of the number of the solutions or the convergence and the diversity, the MOEA-PM algorithm is superior to other algorithms.

It is found that MOEA-PM (Random) performs the worst, that is because most of the individuals in the completely random initial population are ineffective, which will weaken the evolutionary power of the algorithm, so it is difficult for MOEA-PM (Random) to have the convergence within a small number of fitness evaluations. The performance of the MOPM algorithm is better than that of the MOEA-PM (Random) algorithm. The reason lies in the population initialized by the meta-pattern and the transaction-pattern not only ensures that the individuals in the initial population are effective, but also combines the advantages of the two patterns. The performance of the MOEA-FHUI (NSGA-II) algorithm is similar to the MOPM algorithm and slightly better than the MOPM in some datasets. This shows that the population initialization method of MOEAFHUI (NSGA-II) is better than that of MOPM to some extent. Since the initial population of the MOEA-PM (Meta.) algorithm usually has a high support value but a poor distribution, the solutions explored in the finite number of fitness evaluations mainly focus on the location of the high support value in the solution space. Similarly, the solutions explored by the MOEA-PM (Trans.) in a finite number of fitness evaluations are mainly distributed in the location of the high support value in the solution space.

The MOEA-PM algorithm proposed by the disclosure solves the above problems by using the special population initialization and the improved crossover and mutation operators. On the one hand, it guarantees that the algorithm is in a better state before the evolution. On the other hand, the random combination of the itemset in the evolution process is prevented and the efficiency is improved. Therefore, the performance in FIGS. 4-7 is the best.

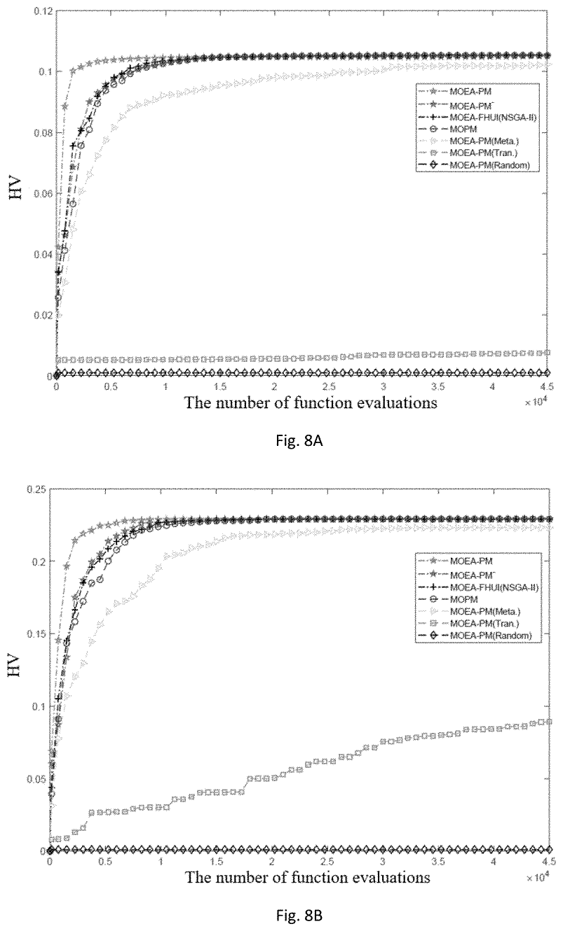

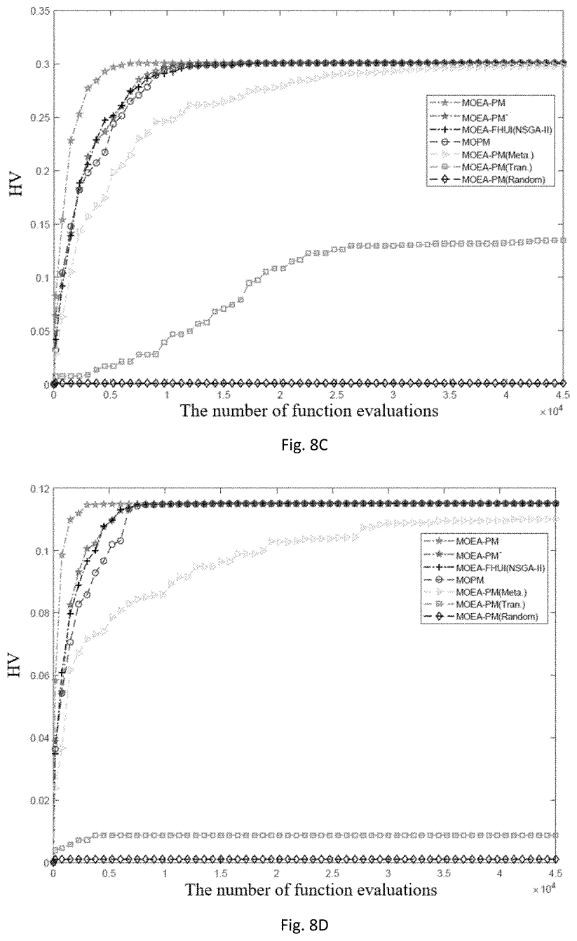

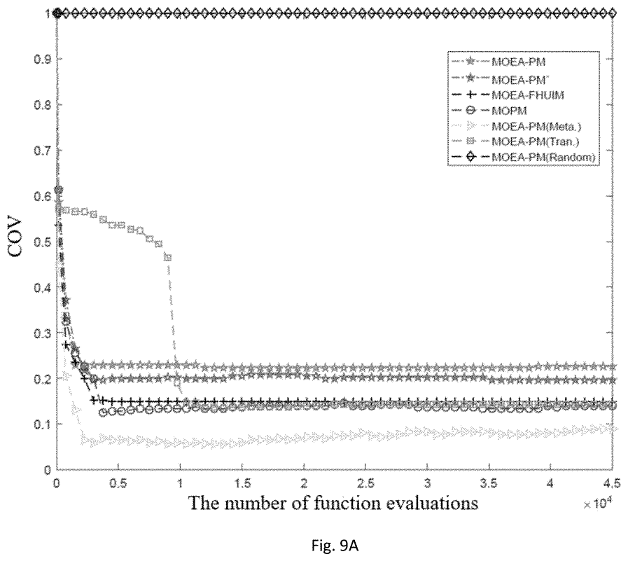

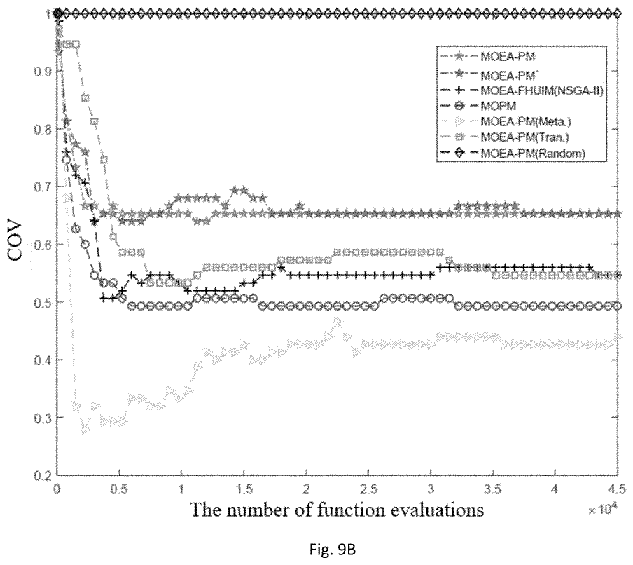

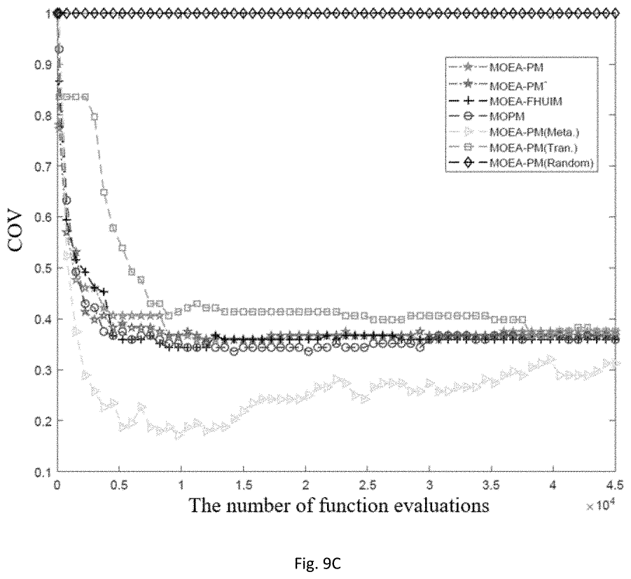

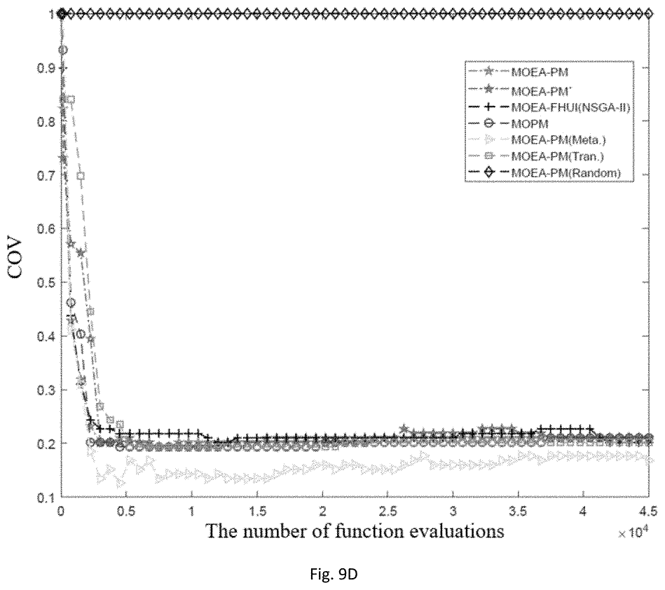

In order to evaluate the quality of the final pattern mined by each algorithm, the population size of all the above algorithms is 150 and the maximum number of evaluations is 45000. The HV and COV values of the four datasets at the different numbers of function evaluations are as shown in FIGS. 8A-8D to FIGS. 9A-9D. FIG. 8A and FIG. 9A are corresponding to the accident_10% dataset, FIG. 8B and FIG. 9B are corresponding to the chess dataset, FIG. 8C and FIG. 9C are corresponding to the connect_50% set, and FIG. 8D and FIG. 9D are corresponding to the mushroom dataset. As can be seen from FIGS. 8A-8D, MOEA-PM has the fastest convergence speed on HV compared with other algorithms, which indicates that the algorithm can achieve a balance of convergence and diversity at a faster speed. The HV convergence speed of MOEA-HUIM (NSGA-II) is better than that of MOPM and the fluctuation of MOEA-HUIM (NSGA-II) is less than that of MOPM. That is because the initial population of MOEA-HUIM (NSGAII) is randomly selected according to the support and utility of the proposed two patterns, so the convergence speed is relatively fast. The performance of MOEA-PM—is similar to that of MOEA-HUIM (NSGA-II) and basically better than the latter, which indicates that the proposed population initialization strategy is effective. However, the convergence speed of HV by MOEAPM- is not as fast as MOEA-PM, which indicates that the improved genetic operator proposed has a greater impact on the convergence and distribution of the algorithm and also indirectly proves the effectiveness of the improved genetic operator of the disclosure.

From FIG. 9A to FIG. 9D, it can be seen that MOEA-PM obtains a faster convergence speed in COV, and the curve fluctuation is relatively gentle. In combination with FIGS. 8A-8D and FIGS. 9A-9D, it can be seen that MOEAPM (Random) still cannot converge even if the fitness evaluations are increased. This indicates that the invalid solutions generated by the random population initialization method will affect the environmental selection ability of the algorithm and seriously weaken the evolutional ability. Therefore, it is difficult for the algorithm to converge within the finite number of fitness evaluations. Although MOEA-PM (Meta.) and MOEA-PM (Tran.) can guarantee the effectiveness of the initial population, due to the uneven distribution of the initial population in the search space and poor diversity, it will affect the ability of the algorithm to explore in the early stage of evolution, so the convergence speed is slower. Experiments show that the proposed MOEA-PM algorithm is superior to the compared algorithms in both the convergence speed and the quality of the final solutions.

Some steps in the embodiments of the disclosure can be implemented by software. The corresponding software programs can be stored in readable storage mediums, such as optical disc or hard disk.

The foregoing is only preferred exemplary embodiments of the disclosure and is not intended to be limiting of the disclosure, and any modifications, equivalent substitutions, improvements and the like within the spirit and principles of the disclosure are intended to be embraced by the protection range of the disclosure.

1. A file storage processing method applied in a hybrid file system architecture including a plurality of different types of distributed file systems, for determining in which distributed file system a file to be stored is stored, the file storage processing method comprising:
acquiring storage attributes of the file to be stored, wherein, the storage attributes at least include a size of the file;
determining, according to a pre-configured storage rule and the storage attributes of the file to be stored, in which distributed file system the file to be stored is stored; and
storing the file to be stored in the determined distributed file system,
wherein, the storage rule is an intelligent storage model obtained through learning by using an artificial intelligence learning algorithm based on a training sample set; and features of each training sample of the training sample set include storage attributes of a file and a label of the file system to which the file has been determined to be assigned.

2. (canceled)

3. The file storage processing method according to claim 1, wherein, the storage attributes of the file further include:
access mode, access permission, and associated owner of the file,
an access mode type is selected from one of: read-only, write-only, read-write, and executable.

4. The file storage processing method according to claim 1, the hybrid file system architecture including a metadata manage server,
wherein, the storage rule is stored in a non-volatile storage medium, and meanwhile maintained in a metadata manage server memory; and
the storage rule is dynamically updated,
wherein, the determining, according to a pre-configured storage rule and the attributes of the file to be stored, in which distributed file system the file to be stored is stored includes:
reading the storage rule from the metadata manage server, and determining, according the read storage rule and the attributes of the file to be stored, in which distributed file system the file to be stored is stored.

5. The file storage processing method according to claim 4, wherein, the storage rule is further maintained in a remote standby node.

6. The file storage processing method according to claim 1, wherein, the artificial intelligence learning algorithm is a decision tree, and the intelligent storage model is a decision tree model constructed based on training data.

7. The file storage processing method according to claim 5, wherein, optimization processing including pruning and cross-validation is performed in construction of the decision tree model.

8. The file storage processing method according to claim 6, further comprising:
receiving, by the metadata manage server, from a client a request to read a file from the hybrid file system architecture or update a file therein;
acquiring, by the metadata manage server, path information of the file to be read or updated, to further obtain storage location information of the file;
returning, by the metadata manage server, the storage location of the file to be read or updated to the client; and
communicating, by the client, with a corresponding distributed file system according to the returned storage location, to perform actual read operation or update operation.

9. The file storage processing method according to claim 5, wherein, the label of the file system to which the file has been determined to be assigned is determined based on I/O performance of the file on each of the distributed file systems, and the I/O performance of the file on each of the distributed file systems is determined experimentally as follows:
acquiring a read throughput rate Fᵢᵣₜ and a write throughput rate F_{iwt} of the file on each distributed file system through experiments, the read throughput rate Fᵢᵣₜ being a data size of the file read per second, and the write throughput rate F_{iwt} being a data size of the file written per second; and
calculating a sum of the read throughput rate Fᵢᵣₜ and the write throughput rate F_{iwt} of the file in each distributed file system as the I/O performance of the file on each of the distributed file systems.

10. The file storage processing method according to claim 1, further comprising:
determining a distributed file system that needs file migration;
determining a file to be migrated on the distributed file system and a migration destination, for the distributed file system that needs file migration; and
migrating the file that has been determined to be migrated.

11. The file storage processing method according to claim 10, wherein, the determining a distributed file system that needs file migration includes:
calculating a difference in usage rate between any two distributed file systems; and
determining that a distributed file system with a higher usage rate needs file migration, when the difference in usage rate is greater than a predetermined threshold.

12. The file storage processing method according to claim 10, wherein, the determining a file to be migrated on the distributed file system, for the distributed file system that needs file migration includes:
calculating a migration gain of migrating each file in the distributed file system that needs file migration to any one of other distributed file systems; and
determining the file to be migrated and the migration destination of the file based on sorting of migration gains of migrating respective files to other distributed file systems.

13. The file storage processing method according to claim 12, wherein, the calculating a migration gain of migrating each file in the distributed file system that needs file migration to any one of other distributed file systems includes:
referring to the distributed file system that needs file migration as a distributed file system i, referring to any one of the other distributed file systems as a distributed file system j, and referring to a file on the distributed file system i as a file x;
obtaining read throughput and write throughput of the file x on the distributed file system i, and predicting read throughput and write throughput of the file x on the distributed file system j;
obtaining a read frequency and a write frequency of the file x on the distributed file system i; and
calculating a migration gain of migrating the file x from the distributed file system i to the distributed file system j, at least based on the size of the file x, the read frequency and the write frequency of the file x on the distributed file system i, the read throughput and the write throughput of the file x on the distributed file system i, as well as the read throughput and the write throughput of the file x on the distributed file system j.

14. The file storage processing method according to claim 13, wherein, the migration gain of migrating the file x from the distributed file system i to the distributed file system j is calculated based on a formula below:
diffₓ(DFSᵢ, DFSⱼ)=(sₓ/Fₓᵣₜ(DFSᵢ)−sₓ/Fₓᵣₜ(DFSⱼ))*F_{xrf}+(sₓ/F_{xwt}(DFSᵢ)−sₓ/F_{xwt}(DFSᵢ)*F_{xwt} (1)
DFSᵢ and DFSⱼ represent the distributed file systems i,j; Fₓᵣₜ(DFSᵢ) and Fₓᵣₜ(DFSⱼ) are respectively read throughput rates of the file x in the distributed file systems i, j; F_{xwt}(DFSᵢ) and F_{xwt}(DFSⱼ) are write throughput rates of the file x in the distributed file systems i, j; a throughput rate is a size of a file read and written per second; the read throughput rate and the write throughput rate are functions of the file size; F_{xrf} and F_{xwf} are respectively the read frequency and the write frequency of the file x in the distributed file system i; and sₓ is a size of the file x to be migrated in the file system.

15. The file storage processing method according to claim 13, wherein, the predicting read throughput and write throughput of the file x on the distributed file system j includes:
predicting by using a predetermined regression model, the regression model being selected from one of:

| model | regression equation |
|---|---|
| first-order | y(k) = [symbol] + [symbol] |
| model | |
| second-order | y(k) = a₀ + a₁0^{-pk} + a₂a−^{Pak} |
| model | |
| third-order | y(k) = a0 + [symbol] + a10^{-pk} + be^{-0wk} [symbol] \sqrt{(w1− )} + ce^{-0wk} sin \sqrt{(w1− )} |
| model | y(k) = [symbol] |
| fourth-order | |
| model | |

[symbol]

indicates data missing or illegible when filed
the predetermined regression model is determined through a fitting process and a selecting process below: inputting file training data to different types of regression models; calculating unknown parameters by using a least square method; fitting to obtain the different types of regression models after the fitting; and selecting a regression model with a best fitting effect from the different types of regression models after the fitting as the predetermined regression model.

16. The file storage processing method according to claim 13, wherein, the obtaining a read frequency and a write frequency of the file x on the distributed file system i includes:
obtaining the read frequency and the write frequency of the file x on the distributed file system i by querying the metadata manage server.

17. A file dynamic migration method applied in a hybrid file system architecture including a plurality of different types of distributed file systems, comprising:
determining a distributed file system that needs file migration;
determining a file to be migrated on the distributed file system and a migration destination, for the distributed file system that needs file migration; and
migrating the file that has been determined to be migrated, wherein, the determining a distributed file system that needs file migration includes:
calculating a difference in usage rate between any two distributed file systems; and
determining that a distributed file system with a higher usage rate needs file migration, when the difference in usage rate is greater than a predetermined threshold.

18. (canceled)

19. The file dynamic migration method according to claim 17, wherein, the determining a file to be migrated on the distributed file system, for the distributed file system that needs file migration includes:
calculating a migration gain of migrating each file in the distributed file system that needs file migration to any one of other distributed file systems; and
determining the file to be migrated and the migration destination of the file based on sorting of migration gains of migrating respective files to other distributed file systems.

20. The file dynamic migration method according to claim 19, wherein, the calculating a migration gain of migrating each file in the distributed file system that needs file migration to any one of other distributed file systems includes:
referring to the distributed file system that needs file migration as a distributed file system i, referring to any one of the other distributed file systems as a distributed file system j, and referring to a file on the distributed file system i as a file x;
obtaining read throughput and write throughput of the file x on the distributed file system i, and predicting read throughput and write throughput of the file x on the distributed file system j;
obtaining a read frequency and a write frequency of the file x on the distributed file system i; and
calculating a migration gain of migrating the file x from the distributed file system i to the distributed file system j, at least based on the size of the file x, the read frequency and the write frequency of the file x on the distributed file system i, the read throughput and the write throughput of the file x on the distributed file system i, as well as the read throughput and the write throughput of the file x on the distributed file system j.

21. The file dynamic migration method according to claim 20, wherein, the migration gain of migrating the file x from the distributed file system i to the distributed file system j is calculated based on a formula below:
diffₓ(DFSᵢ, DFSⱼ)=(sₓ/Fₓᵣₜ(DFSᵢ)−sₓ/Fₓᵣₜ(DFSⱼ))*F_{xrf}+(sₓ/F_{xwt}(DFSᵢ)−sₓ/F_{xwt}(DFSᵢ))*F_{xwf} (1)
DFSᵢ and DFSⱼ represent the distributed file systems i, j; Fₓᵣₜ(DFSᵢ) and Fₓᵣₜ(DFSⱼ) are respectively read throughput rates of the file x in the distributed file systems i, j ; F_{xwt}(DFSᵢ) and F_{xwt}(DFSⱼ) are write throughput rates of the file x in the distributed file systems i, j ; a throughput rate is a size of a file read and written per second; the read throughput rate and the write throughput rate are functions of the file size; F_{xrf} and F_{xwf} are respectively the read frequency and the write frequency of the file x in the distributed file system i; and sₓ is a size of the file x to be migrated in the file system.

22-27. (canceled)

28. A metadata manage server in a hybrid file system architecture system, which interacts with a client and a plurality of distributed file systems, the metadata manage server maintaining a pre-configured storage rule below, and being configured to perform a method below:
acquiring storage attributes of a file to be stored, wherein, the storage attributes at least include a size of the file;
determining, according to a pre-configured storage rule and the attributes of the file to be stored, in which distributed file system the file to be stored is stored;
determining a distributed file system that needs file migration;
determining a file to be migrated on the distributed file system and a migration destination, for the distributed file system that needs file migration; and
migrating the file that has been determined to be migrated,
wherein, the storage rule is an intelligent storage model obtained through learning by using an artificial intelligence learning algorithm based on a training sample set; and features of each training sample of the training sample set include storage attributes of a file and a label of the file system to which the file has been determined to be assigned.

29. (canceled)
